(19) United States
(12) Patent Application Publication
(10) Pub. No.: US 2022/0009458 A1
(43) Pub. Date: Jan. 13, 2022

(54) STOP ASSIST DEVICE

(71) Applicant: TOYOTA JIDOSHA KABUSHIKI KAISHA, Toyota-shi (JP)

(72) Inventor: Chenyu WANG, Toyota-shi (JP)

(73) Assignee: TOYOTA JIDOSHA KABUHIKI KAISHA, Toyota-shi (JP)

(21) Appl. No.: 17/363,689

(22) Filed: Jun. 30, 2021

(30) Foreign Application Priority Data
Jul. 10, 2020 (JP) 2020-118880

(51) Int. Cl. B60T 7/12; B60Q 1/52; B60Q 1/00

(52) U.S. Cl. CPC B60T 7/12; B60K 28/066; B60Q 1/0076; B60Q 1/52

(57) ABSTRACT

A stop assist device is equipped with an operation switch that is operated to activate and deactivate a hazard lamp of a vehicle. The stop assist device starts stop assist control for stopping the vehicle through automatic deceleration of the vehicle and starts activating the hazard lamp from an abnormality detection timing when it is determined that an abnormality condition that is fulfilled when a driver falls into an abnormal state in which the driver is unable to drive the vehicle is fulfilled. The stop assist device continues to perform stop assist control when the operation switch is operated before the lapse of a predetermined invalid time from the abnormality detection timing during the performance of stop assist control, and ends stop assist control when the operation switch is operated after the lapse of the invalid time from the abnormality detection timing during the performance of stop assist control.

### CROSS-REFERENCE TO RELATED APPLICATION

This application claims priority to Japanese Patent Application No. 2020-118880 filed on Jul. 10, 2020, incorporated herein by reference in its entirety.

### BACKGROUND

### 1. Technical Field

The disclosure relates to a stop assist device that performs stop assist control for stopping a vehicle by decelerating the vehicle when a driver falls into an abnormal state.

### 2. Description of Related Art

Conventionally, there is known a stop assist device that performs stop assist control for stopping a vehicle by decelerating the vehicle when a driver falls into an abnormal state. For example, a stop assist device described in Japanese Unexamined Patent Application Publication No. 2010-125923 (JP 2010-125923 A) (hereinafter referred to as “a conventional device”) determines whether or not a driver has fallen into an abnormal state, and starts stop assist control when it is determined that the driver has fallen into the abnormal state. In this stop assist control, the conventional device determines a stop position in accordance with the shape of a road on which a vehicle runs, and stops the vehicle at the stop position.

### SUMMARY

A hazard switch (a hazard lamp switch) that is operated to blink or turn off hazard lamps of a vehicle is provided in a cabin of the vehicle. The hazard switch will be referred to hereinafter simply as “an operation switch” in some cases. The operation switch is provided at a position that allows not only a driver seated in a driver seat of the vehicle but also a passenger seated in a front passenger seat of the vehicle to operate the operation switch.

During the performance of stop assist control, the operation switch may be operated by the driver or a passenger other than the driver. In the case where the operator of the operation switch is the driver, when the driver recovers from an abnormal state to a normal state during the performance of stop assist control, the operation switch is likely to have been operated to turn off the blinking hazard lamps. Incidentally, the hazard lamps are blinked during the performance of stop assist control. On the other hand, in the case where the operator of the operation switch is the passenger, the operation switch is likely to have been operated to blink the hazard lamps when the passenger notices that the driver has fallen into the abnormal state.

When the driver operates the operation switch during the performance of stop assist control, the driver is likely to have recovered from the abnormal state to the normal state, so the stop assist device is desired to end stop assist control. On the other hand, when the passenger operates the operation switch during the performance of stop assist control, the driver is likely to be in the abnormal state, so the stop assist device is desired to continue stop assist control instead of ending stop assist control.

In the conventional device, it is not considered which type of control should be performed when the operation switch is operated during the performance of stop assist control.

The disclosure has been made to cope with the foregoing problem. That is, it is an object of the disclosure to provide a stop assist device that appropriately determines whether stop assist control should be continued or ended when an operation switch is operated during the performance of stop assist control.

A stop assist device of the disclosure (hereinafter referred to also as “the device of the disclosure”) is equipped with an operation switch (26) that is operated to activate a hazard lamp (60) of a vehicle and deactivate the hazard lamp, and a control unit (20) configured to determine whether or not an abnormality condition that is fulfilled when a driver of the vehicle falls into an abnormal state in which the driver is unable to drive the vehicle is fulfilled (step 315 and step 330), and start stop assist control for stopping the vehicle through automatic deceleration of the vehicle (step 335 and steps 500 to 595) and start activating the hazard lamp (step 335 and step 710) upon the arrival of an abnormality detection timing when it is determined that the abnormality condition is fulfilled (“Yes” in step 315 and “Yes” in step 330). The control unit is configured to continue to perform the stop assist control when the operation switch is operated before the lapse of a predetermined invalid time from the abnormality detection timing during the performance of the stop assist control (“Yes” in step 645), and end the stop assist control (step 650) when the operation switch is operated after the lapse of the invalid time from the abnormality detection timing during the performance of the stop assist control (“No” in step 645).

In order for the driver to recover from the abnormal state to a normal state, a certain length of time is likely to be required from the timing when the driver falls into the abnormal state. Therefore, when the operation switch is operated after the lapse of the invalid time from the abnormality detection timing, the operation of the operation switch is likely to have been performed by the driver who has recovered from the abnormal state. Thus, the device of the disclosure determines that the driver has recovered to the normal state, and ends stop assist control, when the operation switch is operated after the lapse of the invalid time from the abnormality detection timing.

On the other hand, a passenger is likely to notice that the driver has fallen into the abnormal state, immediately after the fall of the driver into the abnormal state. Therefore, when the operation switch is operated before the lapse of the invalid time from the abnormality detection timing, the operation of the operation switch is likely to have been performed by the passenger who has noticed that the driver has fallen into the abnormal state. Thus, the device of the disclosure determines that the driver is still in the abnormal state, and continues stop assist control, when the operation switch is operated before the lapse of the invalid time from the abnormality detection timing.

Owing to the foregoing, the device of the disclosure can appropriately determine whether stop assist control should be continued or ended when the operation switch is operated during the performance of stop assist control.

In another aspect of the disclosure, the control unit may be configured to determine whether or not a tentative abnormality condition including only one or some of conditions for fulfilling the abnormality condition is fulfilled (step 315 and step 805 shown in FIG. 8), and start activating the hazard lamp and start the stop assist control (step 910 and steps 500 to 595) when the operation switch is operated in a period from a tentative abnormality detection timing when it is determined that the tentative abnormality condition is fulfilled (“Yes” in step 805) to the abnormality detection timing (“Yes” in step 330 shown in FIG. 8).

According to the present aspect, when the operation switch is operated in the period from the tentative abnormality detection timing to the abnormality detection timing, it is determined that the operation of the operation switch has been performed by the passenger who has noticed that the driver has fallen into the abnormal state, the activation of the hazard lamp is started, and stop assist control is started. Thus, when the passenger notices that the driver has fallen into the abnormal state, and operates the operation switch before the abnormality detection timing, start assist control can be started, even before the fulfillment of the abnormality condition. Furthermore, stop assist control is not started unless the tentative abnormality condition is fulfilled. Therefore, the possibility of stop assist control being erroneously started can be reduced.

In still another aspect of the disclosure, the control unit may be configured to continue activation of the hazard lamp when the operation switch is operated before the lapse of the invalid time from the abnormality detection timing during the performance of the stop assist control.

According to the present aspect, when the operation switch is operated before the lapse of the invalid time from the abnormality detection timing, the activation of the hazard lamp is continued to continue to perform stop assist control. Thus, the hazard lamp can be prevented from being deactivated although stop assist control is performed.

In still another aspect of the disclosure, the operation switch may be configured to move to an on position upon being subjected to pressing operation when the operation switch is at an off position, remain at the on position when the pressing operation is canceled, move to the off position upon being subjected to pressing operation when the operation switch is at the on position, and remain at the off position when the pressing operation is canceled, and the control unit may be configured to activate the hazard lamp as long as the operation switch is at the on position, even when the operation switch is operated after the lapse of the invalid time from the abnormality detection timing during the performance of the stop assist control.

According to the present aspect, when the operation switch is operated after the lapse of the invalid time from the abnormality detection timing during the performance of stop assist control, the hazard lamp is activated as long as the operation switch is at the on position. Thus, the hazard lamp can be prevented from being deactivated although the operation switch is at the on position, and the driver can be prevented from getting confused due to a change in the relationship between the operating position of the operation switch and the activation state of the hazard lamp.

In still another aspect of the disclosure, the control unit may be configured to continue activation of the hazard lamp when the operation switch is operated after the lapse of the invalid time from the abnormality detection timing during the performance of the stop assist control.

According to the present aspect, the hazard lamp can be prevented from being deactivated although, for example, the operation switch is at the on position, and the driver can be prevented from getting confused.

In still another aspect of the disclosure, the control unit may be configured to deactivate the hazard lamp when the operation switch is operated after the lapse of the invalid time from the abnormality detection timing during the performance of the stop assist control.

According to the present aspect, the hazard lamp can be prevented from remaining activated although, for example, the operation switch is at the off position, and the driver can be prevented from getting confused.

Incidentally, in the foregoing description, the configurational details of the disclosure corresponding to an embodiment that will be described later are accompanied by names and/or symbols used in the embodiment in parentheses, to facilitate the understanding of the disclosure. However, the respective components of the disclosure are not limited to the embodiment prescribed by the names and/or the symbols. Other objects, features, and ancillary advantages of the disclosure will be easily understandable from the embodiment of the disclosure that will be described with reference to the following drawings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration view of a stop assist device according to one of the embodiments of the disclosure;

FIG. 2 is a timing chart for illustrating the operation of the stop assist device;

FIG. 3 is a flowchart showing an abnormal state detection routine that is executed by a CPU of a stop assist ECU (hereinafter referred to simply as “the CPU”);

FIG. 4 is a flowchart showing a recovery detection routine that is executed by the CPU;

FIG. 5 is a flowchart showing a stop assist control routine that is executed by the CPU;

FIG. 6 is a flowchart showing a hazard switch operation control routine that is executed by the CPU;

FIG. 7 is a flowchart showing an operation control routine that is executed by the CPU;

FIG. 8 is a flowchart showing an abnormal state detection routine that is executed by a CPU of a modification example of the embodiment of the disclosure; and

FIG. 9 is a flowchart showing part of a hazard switch operation control routine that is executed by the CPU of the modification example of the embodiment of the disclosure.

### DETAILED DESCRIPTION OF EMBODIMENTS

(Configuration)

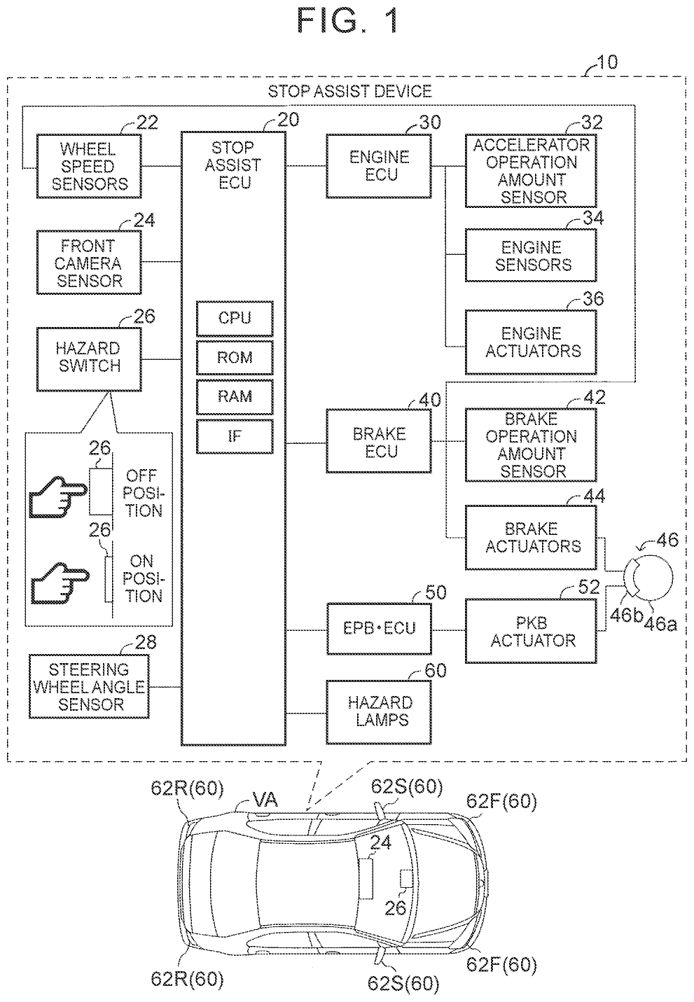

As shown in FIG. 1, a stop assist device 10 according to one of the embodiments (hereinafter referred to as “the present assist device 10”) is applied to a vehicle VA. The present assist device 10 is equipped with a stop assist ECU 20, an engine ECU 30, a brake ECU 40, and an electric parking brake ECU (hereinafter referred to as “the EPB-ECU”) 50. These ECU's are connected to one another in such a manner as to be able to transmit/receive data to/from one another via a controller area network (CAN).

Each of the ECU's is the abbreviation of an electronic control unit, which has, as a main component, a microcomputer including a CPU, a ROM, a RAM, an interface, and the like. The CPU realizes various functions by executing instructions (routines) stored in a memory (the ROM). Some or all of the ECU's 20, 30, 40, and 50 may be integrated into a single ECU.

The present assist device 10 is equipped with a plurality of wheel speed sensors 22, a front camera sensor 24, a hazard switch (hereinafter referred to as “an operation switch” in some cases) 26, and a steering wheel angle sensor 28. These components are connected to the stop assist ECU 20.

The wheel speed sensors 22 are provided for wheels of the vehicle VA respectively. Each of the wheel speed sensors 22 generates a single wheel pulse signal every time the corresponding one of the wheels rotates by a predetermined angle. The stop assist ECU 20 counts the number of pulses of wheel pulse signals transmitted from each of the wheel speed sensors 22 per unit time, and acquires a rotational speed of each of the wheels (a wheel speed) based on the number of pulses. The stop assist ECU 20 acquires a vehicle speed Vs indicating a speed of the vehicle VA, based on the wheel speeds of the respective wheels. For instance, the stop assist ECU 20 acquires an average of the wheel speeds of the four wheels as the vehicle speed Vs.

As shown in FIG. 1, the front camera sensor 24 is disposed on an upper portion of a windshield in a cabin of the vehicle VA. The front camera sensor 24 acquires image data on an image (a camera image) of an area in front of the vehicle VA, and acquires object information (a distance to an object, an orientation of the object, and the like), “white line information on white lines (compartment lines) defining a lane in which the vehicle runs”, and the like from the image.

As shown in FIG. 1, the hazard switch 26 is disposed in the vicinity of a center of an instrument panel in a vehicle width direction in the cabin of the vehicle VA. The hazard switch 26 is operated by a driver of the vehicle VA and a passenger (a passenger seated in a front passenger seat) other than the driver of the vehicle VA, so as to activate and deactivate hazard lamps 60 that will be described later. The passenger other than the driver who can operate the hazard switch 26 will be referred to hereinafter simply as “the passenger” in some cases.

When the driver or the passenger (hereinafter referred to as “an operator”) performs pressing operation of the hazard switch 26 located at an off position, the hazard switch 26 moves from the off position to an on position. When the pressing operation is cancelled, the hazard switch 26 remains at the on position. When the operator performs pressing operation of the hazard switch 26 located at the on position, the hazard switch 26 moves from the on position to the off position. When the pressing operation is cancelled, the hazard switch 26 remains at the off position.

The steering wheel angle sensor 28 detects a steering wheel angle θw that is a rotational angle of a steering wheel (not shown) of the vehicle VA from a neutral position thereof, and transmits a detection signal representing the steering wheel angle θw to the stop assist ECU 20.

The engine ECU 30 is connected to an accelerator operation amount sensor 32 and engine sensors 34, and receives detection signals of these sensors.

The accelerator operation amount sensor 32 detects an operation amount (i.e., an accelerator operation amount AP) of an accelerator pedal (not shown) of the vehicle VA. The accelerator operation amount AP is “0” when the driver does not depress the accelerator pedal. The accelerator operation amount AP increases as the depression amount of the accelerator pedal increases.

Each of the engine sensors 34 is a sensor that detects an operating state amount of “a gasoline fuel injection-type, spark ignition internal combustion engine that is a drive source of the vehicle VA” (not shown). The engine sensors 34 are a throttle valve opening degree sensor, an engine rotational speed sensor, an intake air amount sensor, and the like.

Furthermore, the engine ECU 30 is connected to engine actuators 36 such as “a throttle valve actuator and a fuel injection valve” and the like. The engine ECU 30 changes the torque generated by the internal combustion engine by driving the engine actuators 36, and thus adjusts the driving force of the vehicle VA.

The engine ECU 30 determines a target throttle valve opening degree TAtgt such that the target throttle valve opening degree TAtgt increases as the accelerator operation amount AP increases. The engine ECU 30 drives the throttle valve actuator such that the opening degree of the throttle valve coincides with the target throttle valve opening degree TAtgt.

The brake ECU 40 is connected to the wheel speed sensors 22 and a brake operation amount sensor 42, and receives detection signals of these sensors.

The brake operation amount sensor 42 detects an operation amount (i.e., a brake operation amount BP) of a brake pedal (not shown) of the vehicle VA. The brake operation amount BP is “0” when the driver does not operate the brake pedal. The brake operation amount BP increases as the depression amount of the brake pedal increases.

As is the case with the stop assist ECU 20, the brake ECU 40 acquires the rotational speeds of the respective wheels and the vehicle speed Vs, based on the wheel pulse signals from the wheel speed sensors 22. Incidentally, the brake ECU 40 may acquire these values from the stop assist ECU 20.

Furthermore, the brake ECU 40 is connected to brake actuators 44. Each of the brake actuators 44 is an actuator that controls the corresponding one of friction brake mechanisms 46, and includes a known hydraulic circuit. Each of the friction brake mechanisms 46 is equipped with a brake disc 46a fixed to the corresponding one of the wheels, and a brake caliper 46b fixed to a vehicle body. Each of the brake actuators 44 adjusts a hydraulic pressure supplied to a wheel cylinder built in the brake caliper 46b, in accordance with a command from the brake ECU 40, and generates a friction braking force by pressing a brake pad against the brake disc 46a by the hydraulic pressure. Accordingly, the brake ECU 40 can control the braking force of the vehicle VA and change the state of acceleration (deceleration, i.e., negative acceleration) by controlling the brake actuators 44.

The brake ECU 40 determines “a target acceleration Gtgt as a negative value” based on the brake operation amount BP. The brake ECU 50 controls the brake actuators 44 such that the actual acceleration of the vehicle VA coincides with the target acceleration Gtgt.

The EPB-ECU 50 is connected to a parking brake actuator (hereinafter referred to as “a PKB⋅actuator”) 52. The PKB⋅actuator 52 generates a frictional braking force by pressing a brake pad against the brake disc 46a. Alternatively, in the case where a drum brake is provided, the PKB⋅actuator 52 generates a frictional braking force by pressing a shoe against a drum that rotates together with each of the wheels. Accordingly, the EPB-ECU 50 can keep the vehicle stopped, by applying a parking braking force to the wheels through the use of the PKB⋅actuator 52. The braking of the vehicle VA through activation of the PKB⋅actuator 52 will be referred to hereinafter simply as “EPB”.

The hazard lamps 60 are connected to the stop assist ECU 20. The hazard lamps 60 are activated to notify those around the vehicle that the vehicle is about to make a stop. Upon being activated, the hazard lamps 60 blink. Upon being deactivated, the hazard lamps 60 turn off. The hazard lamps 60 are front turn signal lamps 62F, side turn signal lamps 62S, and rear turn signal lamps 62R. The front turn signal lamps 62F are disposed on the right and left sides of a front end of the vehicle VA respectively. The side turn signal lamps 62S are disposed on right and left side mirrors of the vehicle VA respectively. The rear turn signal lamps 62R are disposed on the right and left sides of a rear end of the vehicle VA respectively.

When the hazard switch 26 is located at the on position, the hazard lamps 60 are activated (i.e., the turn signal lamps 60F, 60S, and 60R blink). In contrast, when the hazard switch 26 is located at the off position, the hazard lamps 60 are deactivated (i.e., the turn signal lamps 60F, 60S, and 60R are off).

(Outline of Operation)

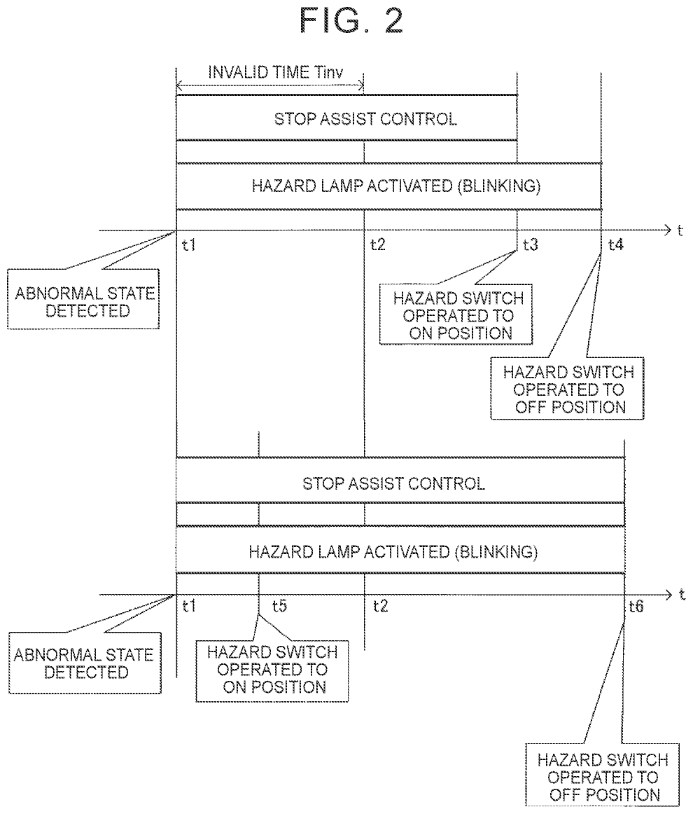

Referring to FIG. 2, the outline of the operation of the present assist device 10 will be described.

The present assist device 10 determines whether or not a predetermined abnormality condition is fulfilled, at intervals of a predetermined time. When it is determined that the abnormality condition is fulfilled, it is determined that the driver has fallen into an abnormal state where he or she is unable to drive the vehicle VA. For instance, the present assist device 10 determines that the abnormality condition is fulfilled, when the amount of change in the steering wheel angle θw has remained equal to or smaller than a threshold angle θwth (hereinafter referred to as “an unoperated state”) for a predetermined first time or more.

A timing when the stop assist device 10 determines that the abnormality condition is fulfilled (i.e., a timing when the stop assist device 10 detects that the driver has fallen into the abnormal state) will be referred to as “an abnormality detection timing”. This abnormality detection timing is expressed as a timing t1 shown in FIG. 2. At the abnormality detection timing (the timing t1), the stop assist device 10 starts performing stop assist control for stopping the vehicle VA by decelerating the vehicle VA, and starts activating (blinking) the hazard lamps 60. Incidentally, the details of stop assist control will be described later.

As shown in an upper chart of FIG. 2, it is assumed that the hazard switch 26 is located at the off position at the timing t1, and that the hazard switch 26 is located at the on position upon being subjected to pressing operation at a timing t3. Incidentally, the timing t3 is a timing upon or after a timing t2 upon the lapse of a predetermined invalid time Tinv from the abnormality detection timing t1.

The present assist device 10 ends stop assist control when the hazard switch 26 is operated after the lapse of the invalid time Tinv from the abnormality detection timing. In the example shown in the upper chart of FIG. 2, the timing t3 when the hazard switch 26 is operated is a timing after the lapse of the invalid time Tinv from the abnormality detection timing. Therefore, the present assist device 10 ends stop assist control at the timing t3.

Furthermore, at the timing t3, the hazard switch 26 is located at the on position, so the present assist device 10 continues to activate (blink) the hazard lamps 60 instead of deactivating the hazard lamps 60. When the hazard switch 26 is operated again at a timing t4 following the timing t3, the hazard switch 26 is located at the off position, so the present assist device 10 deactivates the hazard lamps 60 (turns off the hazard lamps 60).

On the other hand, as shown in a lower chart of FIG. 2, it is assumed that the hazard switch 26 is located at the on position upon being operated at a timing t5 preceding the timing t2. In this case, in the present assist device 10, the hazard switch 26 is operated before the lapse of the invalid time Tinv from the abnormality detection timing t1. In this case, the present assist device 10 continues stop assist control instead of ending stop assist control, and continues to activate the hazard lamps 60. In other words, the present assist device 10 invalidates the operation of the hazard switch 26 at the timing t5.

After that, when the hazard switch 26 is operated at a timing t6 following the timing t2, the present assist device 10 ends stop assist control in the same manner as at the timing t3. The hazard switch 26 is located at the off position due to the operation of the hazard switch 26 at the timing t6. Therefore, the present assist device 10 deactivates the hazard lamps 60 at the timing t6.

As is understood from the foregoing, the present assist device 10 ends stop assist control when the hazard switch 26 is operated upon or after the lapse of the invalid time Tinv from the abnormality detection timing during the performance of stop assist control. On the other hand, the present assist device 10 continues stop assist control when the hazard switch 26 is operated before the lapse of the invalid time Tinv from the abnormality detection timing during the performance of stop assist control.

The reason for ending stop assist control when the hazard switch 26 is operated after the lapse of the invalid time Tinv from the abnormality detection timing, and continuing stop assist control when the hazard switch 26 is operated before the lapse of the invalid time Tinv from the abnormality detection timing will be described hereinafter.

As described above, the hazard switch 26 is operated by any passenger other than the driver as well as the driver. When the driver operates the hazard switch 26 during the performance of stop assist control, the hazard switch 26 is likely to have been operated to turn off the hazard lamps 60 after a recovery of the driver from the abnormal state to a normal state. The driver who has once fallen into the abnormal state is considered to need a certain length of time to recover to the normal state. Therefore, the hazard switch 26 is likely to be operated by this driver after the lapse of the invalid time Tinv from the abnormality detection timing. Furthermore, when the hazard switch 26 is operated by this driver, the driver has recovered to the normal state, so it is desirable to end stop assist control.

In consequence, when the hazard switch 26 is operated after the lapse of the invalid time Tinv from the abnormality detection timing, the present assist device 10 determines that the driver has recovered to the normal state, and ends stop assist control.

On the other hand, when the passenger operates the hazard switch 26 during the performance of stop assist control, the hazard switch 26 is likely to have been operated by the passenger who has noticed that the driver has fallen into the abnormal state. This operation of the hazard switch 26 by the passenger is considered to be likely to be performed at an earlier timing than the foregoing operation of the hazard switch 26 by the driver who has recovered to the normal state, especially immediately after the abnormality detection timing. Therefore, the operation of the hazard switch 26 by this passenger is likely to be performed before the lapse of the invalid time Tinv from the abnormality detection timing. When the hazard switch 26 is operated by this passenger, the driver has fallen into the abnormal state, stop assist control is desired to be continued instead of being ended.

In consequence, when the hazard switch 26 is operated before the lapse of the invalid time Tinv from the abnormality detection timing, the present assist device 10 determines that the driver still remains in the abnormal state, and continues stop assist control.

Incidentally, the invalid time Tinv is desired to be set to a desired value ranging from one second to two seconds.

(Concrete Activation)

(Abnormality State Detection Routine)

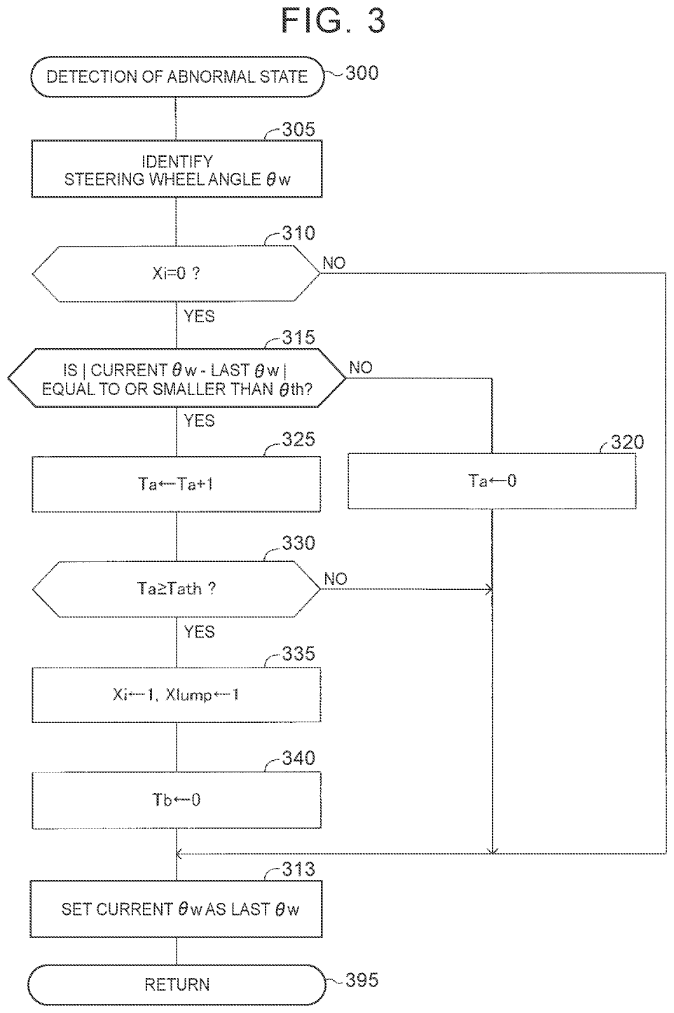

The CPU of the stop assist ECU 20 (in the following description, “the CPU” means the CPU of the stop assist ECU 20 unless otherwise specified) executes an abnormal state detection routine indicated by a flowchart in FIG. 3, at intervals of a predetermined time.

Accordingly, at a predetermined timing, the CPU starts a process from step 300 of FIG. 3, and carries out step 305 and step 310 in this order.

In step 305, the CPU identifies the steering wheel angle θw based on a detection signal from the steering wheel angle sensor 28.

In step 310, the CPU determines whether or not the value of an abnormality flag Xi is “0”.

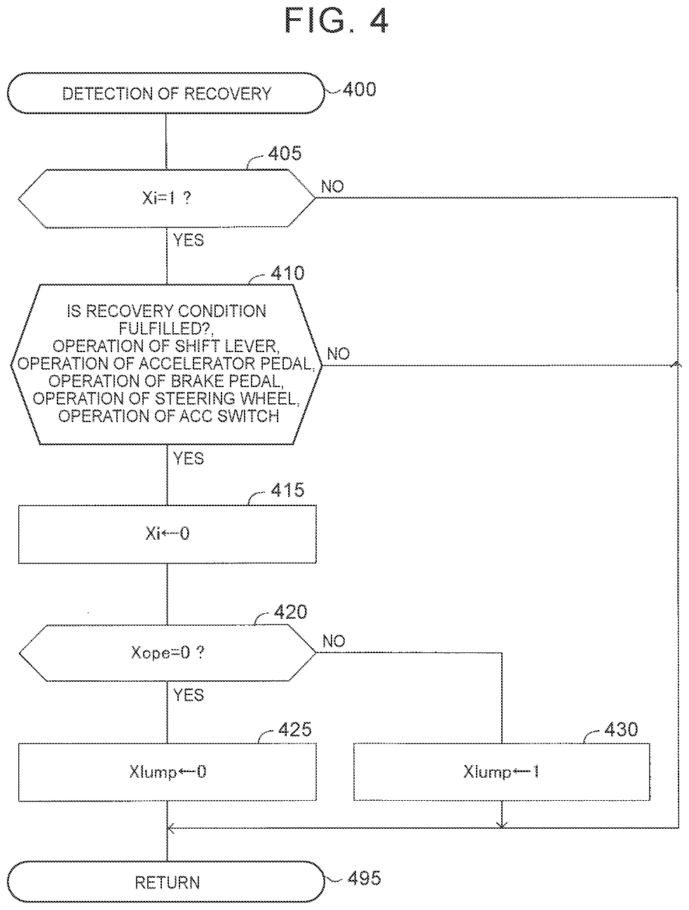

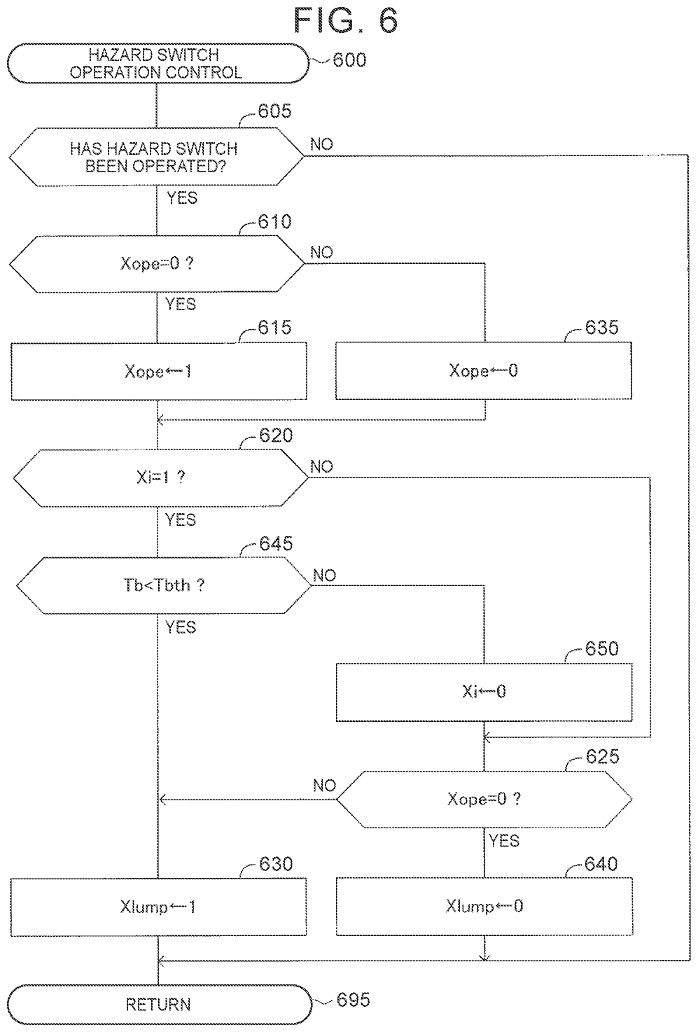

The value of the abnormality flag Xi is set to “1” when it is determined that the driver has fallen into an abnormal state (see step 335 that will be described later). The value of the abnormality flag Xi is set to “0” when it is determined that the driver has recovered from the abnormal state to a normal state (see later-described step 415 shown in FIG. 4 and later-described step 650 shown in FIG. 6). Incidentally, the value of the abnormality flag Xi is set to “0” in an initial routine that is executed by the CPU when an ignition key switch (not shown) of the vehicle VA is changed from an off position to an on position.

When the value of the abnormality flag Xi is “1”, the CPU determines that the result is “No” in step 310, and proceeds to step 313. In step 313, the CPU stores the steering wheel angle θw acquired in step 305 as the last steering wheel angle θw (hereinafter referred to as “the last θw”), and proceeds to step 395 to temporarily end the present routine.

When the value of the abnormality flag Xi is “0”, the CPU determines that the result is “Yes” in step 310, and proceeds to step 315. In step 315, the CPU determines whether or not the absolute value of a substrative value obtained by subtracting the last Ow from the steering wheel angle θw identified in step 305 of the present routine this time (hereinafter referred to as “the current Ow”) is equal to or smaller than a threshold angle θwth.

When the absolute value is larger than the threshold angle θwth, the CPU determines that the result is “No” in step 315, and proceeds to step 320. In step 320, the CPU sets the value of an abnormality detection timer Ta to “0”, carries out step 313, and then proceeds to step 395 to temporarily end the present routine. The abnormality detection timer Ta is a timer for counting a time during which the absolute value remains equal to or smaller than the threshold angle θwth. Incidentally, the state where the absolute value is equal to or smaller than the threshold angle θwth will be referred to as “an unoperated state”.

On the other hand, when the absolute value is equal to or smaller than the threshold angle θwth as soon as the CPU proceeds to step 315, the CPU determines that the result is “Yes” in step 315, and carries out step 325 and step 330 in this order.

In step 325, the CPU adds “1” to the value of the abnormality detection timer Ta.

In step 330, the CPU determines whether or not the value of the abnormality detection timer Ta is equal to or larger than a threshold Tath. The threshold Tath is set in advance such that the value of the abnormality detection timer Ta becomes equal to or larger than the threshold Tath when the unoperated state continues for a first time.

When the value of the abnormality detection timer Ta is smaller than the threshold Tath, the CPU determines that the result is “No” in step 330, carries out step 313, and then proceeds to step 395 to temporarily end the present routine.

When the value of the abnormality detection timer Ta is equal to or larger than the threshold Tath, the CPU determines that an abnormality condition is fulfilled as a result of the continuation of the unoperated state for the first time, and determines that the driver has fallen into the abnormal state. In this state, the CPU determines that the result is “Yes” in step 330, and carries out step 335 and step 340. After that, the CPU carries out step 313, and proceeds to step 395 to temporarily end the present routine.

In step 335, the CPU sets the value of the abnormality flag Xi to “1”, and sets the value of an activation flag Xlump to “1”.

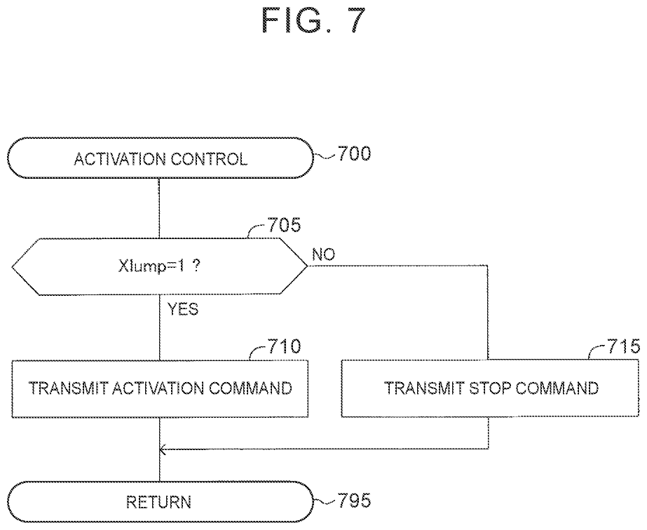

When the value of the activation flag Xlump is set to “1”, the hazard lamps 60 are activated (blink) (see step 710 shown in FIG. 7). When the value of the activation flag Xlump is set to “0”, the hazard lamps 60 are deactivated (the hazard lamps 60 are turned off) (see step 715 shown in FIG. 7). Incidentally, the value of the activation flag Xlump is set to “1” in step 335, later-described step 430 shown in FIG. 4, and later-described step 630 shown in FIG. 6. The value of the activation flag Xlump is set to “0” in later-described step 425 shown in FIG. 4, later-described step 640 shown in FIG. 6, and the foregoing initial routine.

In step 340, the CPU sets the value of an invalid time timer Tb to “0”. The invalid time timer Tb is a timer for counting a time elapsed from a timing when it is determined that the driver has fallen into the abnormal state (i.e., a timing when it is determined that the result is “Yes” in step 330).

(Recovery Detection Routine)

The CPU executes a recovery detection routine indicated by a flowchart in FIG. 4, at intervals of a predetermined time.

Accordingly, at a predetermined timing, the CPU starts a process from step 400 of FIG. 4, and proceeds to step 405. In step 405, the CPU determines whether or not the value of the abnormality flag Xi is “1”.

When the value of the abnormality flag Xi is “0”, the CPU determines that the result is “No” in step 405, and proceeds to step 495 to temporarily end the present routine.

In contrast, when the value of the abnormality flag Xi is “1”, the CPU determines that the result is “Yes” in step 405, and determines whether or not a recovery condition is fulfilled. In more concrete terms, the CPU determines that the recovery condition is fulfilled when at least one of the following conditions 1 to 5 is fulfilled.

The condition 1 is that a shift range at the abnormality detection timing has been changed over to another shift range through the operation of a shift lever (not shown).

The condition 2 is that the absolute value of a subtractive value obtained by subtracting the accelerator operation amount AP at the time of the last execution of the present routine from the accelerator operation amount AP at the time of the current execution of the present routine is equal to or larger than a threshold accelerator operation amount APth.

The condition 3 is that the absolute value of a subtractive value obtained by subtracting the brake operation amount BP at the time of the last execution of the present routine from the brake operation amount BP at the time of the current execution of the present routine is equal to or larger than a threshold brake operation amount BPth.

The condition 4 is that the absolute value of a subtractive value obtained by subtracting the steering wheel angle θw at the time of the last execution of the present routine from the steering wheel angle θw at the time of the current execution of the present routine is equal to or larger than a recovery threshold angle θwth′.

The condition 5 is that an adaptive cruise control (ACC) switch (not shown) has been operated.

ACC includes two kinds of control, namely, constant-speed running control and preceding vehicle follow-up control. Constant-speed running control is the control for causing the vehicle VA to run such that the running speed of the vehicle VA coincides with a target speed (a set speed) Vset, without requiring the operation of the accelerator pedal and the brake pedal. Preceding vehicle follow-up control is the control of causing the vehicle VA to follow a preceding vehicle (a follow-up target vehicle) while keeping the inter-vehicle distance between the follow-up target vehicle and the vehicle VA equal to a target inter-vehicle distance Dset, without requiring the operation of the accelerator pedal and the brake pedal. The follow-up target vehicle is a vehicle that runs in an area in front of the vehicle VA and immediately in front of the vehicle VA.

When none of the foregoing conditions 1 to 5 is fulfilled, the CPU determines that the recovery condition is not fulfilled, and determines that the driver is still in an abnormal state. In this case, the CPU determines that the result is “No” in step 410, and proceeds to step 495 to temporarily end the present routine.

On the other hand, when at least one of the foregoing conditions 1 to 5 is fulfilled, the CPU determines that the recovery condition is fulfilled, and determines that the driver has recovered from the abnormal state to a normal state. In this case, the CPU determines that the result is “Yes” in step 410, and carries out step 415 and step 420 in this order.

In step 415, the CPU sets the value of the abnormality flag Xi to “0”.

In step 420, the CPU determines whether or not the value of an operation flag Xope is “0”.

The value of the operation flag Xope is set to “0” when the hazard switch 26 is located at the off position (later-described step 635 shown in FIG. 6). The value of the operation flag Xope is set to “1” when the hazard switch 26 is located at the on position (later-described step 615 shown in FIG. 6).

When the value of the operation flag Xope is “0”, the CPU determines that the result is “Yes” in step 420, and proceeds to step 425. In step 425, the CPU sets the value of the activation flag Xlump to “0”, and proceeds to step 495 to temporarily end the present routine.

In contrast, when the value of the operation flag Xope is “1”, the CPU determines that the result is “No” in step 420, and proceeds to step 430. In step 430, the CPU sets the value of the activation flag Xlump to “1”, and proceeds to step 495 to temporarily end the present routine.

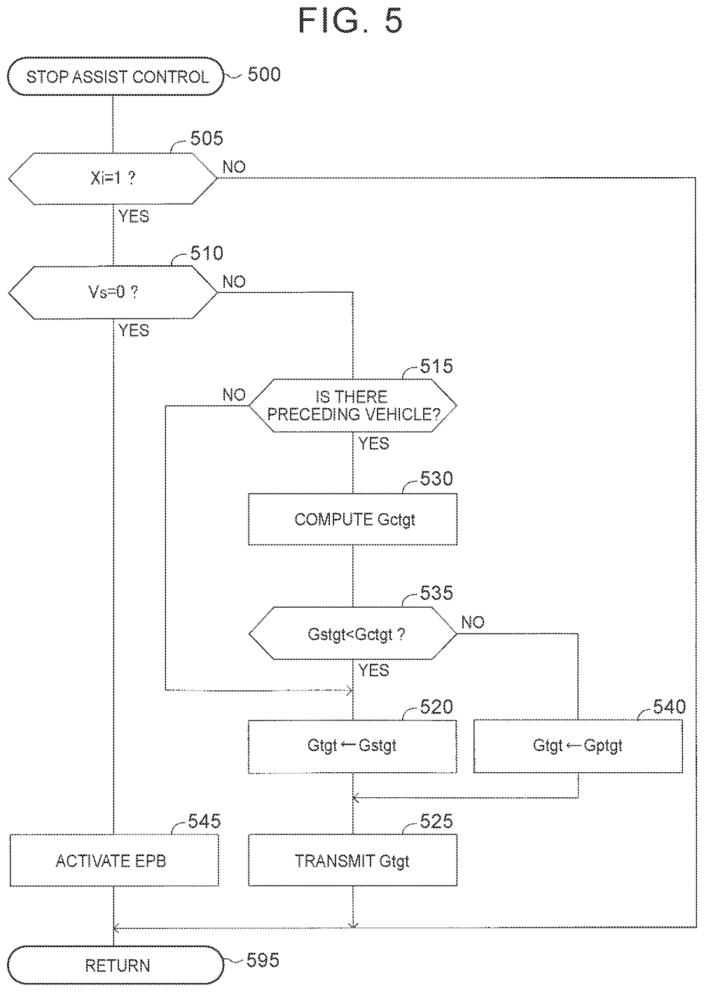

When the value of the abnormality flag Xi is set to “0” in step 415, stop assist control is ended as will be described later (see “No” in step 505 shown in FIG. 5). Therefore, in step 420 and step 430, the CPU controls the activation of the hazard lamps 60 (blinks or turns off the hazard lamps 60) in accordance with the position of the hazard switch 26 in ending stop assist control.

(Stop Assist Control Routine)

The CPU executes a stop assist control routine indicated by a flowchart in FIG. 5, at intervals of a predetermined time.

Accordingly, at a predetermined timing, the CPU starts a process from step 500 of FIG. 5, and proceeds to step 505. In step 505, the CPU determines whether or not the value of the abnormality flag Xi is “1”.

When the value of the abnormality flag Xi is “0”, the CPU determines that the result is “No” in step 505, and proceeds to step 595 to temporarily end the present routine.

On the other hand, when the value of the abnormality flag Xi is “1”, the CPU determines that the result is “Yes” in step 505, and proceeds to step 510. In step 510, the CPU determines whether or not the vehicle speed Vs is “0 km/h”.

When the vehicle speed Vs is not “0 km/h”, the CPU determines that the result is “No” in step 510, and proceeds to step 515 to determine whether or not there is a preceding vehicle.

The processing of step 515 will be described in detail.

The CPU acquires object information and white line information from the front camera sensor 24, and identifies a running lane that is a lane in which the vehicle VA currently runs, based on the white line information. Subsequently, the CPU determines whether or not there is a preceding vehicle that is another vehicle fulfilling all the following conditions 6 to 9, based on the object information.

The condition 6 is that this vehicle runs in the running lane.

The condition 7 is that the distance (inter-vehicle distance) between this vehicle and the vehicle VA is the shortest.

The condition 8 is that the inter-vehicle distance between this vehicle and the vehicle VA is shorter than a predetermined distance.

The condition 9 is that the vehicle VA runs faster than this vehicle while approaching this vehicle.

When there is no preceding vehicle, the CPU determines that the result is “No” in step 515, and carries out step 520 and step 525. After that, the CPU proceeds to step 595 to temporarily end the present routine.

In step 520, the CPU sets a predetermined stop assist acceleration Gstgt (Gstgt<0) as the target acceleration Gtgt.

In step 525, the CPU transmits the target acceleration Gtgt to the engine ECU 30 and the brake ECU 40.

On the other hand, when there is a preceding vehicle as soon as the CPU proceeds to step 515, the CPU determines that the result is “Yes” in step 515, and carries out step 530 and step 535.

In step 530, the CPU computes a collision preventing acceleration Gctgt (Gctgt<0) based on the object information.

To be more specific, the CPU computes, as the collision preventing acceleration Gctgt, an acceleration at which the vehicle speed Vs becomes lower than a vehicle speed Vs' of the preceding vehicle within an estimated collision time Tcol. The CPU computes the estimated collision time Tcol by dividing “the inter-vehicle distance between the preceding vehicle and the vehicle VA” by “a speed of the vehicle VA relative to the preceding vehicle”. Incidentally, the CPU can identify the speed of the vehicle VA relative to the preceding vehicle, based on the vehicle speed Vs and an amount of change from “the inter-vehicle distance between the preceding vehicle and the vehicle VA included in the last object information” to “the inter-vehicle distance between the preceding vehicle and the vehicle VA included in the current object information”. The CPU can also identify the speed Vs' of the preceding vehicle based on the foregoing relative speed and the vehicle speed Vs.

In step 535, the CPU determines whether or not the stop assist acceleration Gstgt is smaller than the collision preventing acceleration Gctgt.

When the stop assist acceleration Gstgt is smaller than the collision preventing acceleration Gctgt, the CPU determines that the result is “Yes” in step 535, and proceeds to step 520 to set the stop assist acceleration Gstgt as the target acceleration Gtgt.

In contrast, when the stop assist acceleration Gstgt is equal to or larger than the collision preventing acceleration Gctgt, the CPU determines that the result is “No” in step 535, and proceeds to step 540.

In step 540, the CPU sets the collision preventing acceleration Gctgt as the target acceleration Gtgt, and transmits the target acceleration Gtgt to the engine ECU 30 and the brake ECU 40 in step 525.

On the other hand, when the vehicle speed Vs is “0” as soon as the CPU proceeds to step 510, the CPU determines that the result is “Yes” in step 510, and proceeds to step 545. In step 545, the CPU transmits an EPB command to the EPB-ECU 50, and proceeds to step 595 to temporarily end the present routine. The EPB-ECU 50 activates the PKB⋅actuator 52, and keeps the vehicle VA stopped.

(Hazard Switch Operation Control Routine)

The CPU executes a hazard switch operation control routine indicated by a flowchart in FIG. 6, at intervals of a predetermined time.

Accordingly, at a predetermined timing, the CPU starts a process from step 600 of FIG. 6, and proceeds to step 605. In step 605, the CPU determines whether or not the hazard switch 26 has been operated between a timing of the last execution of the present routine and the present timing.

When the hazard switch 26 is located at the off position, a predetermined normal voltage is applied to a connection terminal to which the hazard switch 26 of the stop assist ECU 20 is connected. In contrast, when the hazard switch 26 is located at the on position, a predetermined pressing voltage that is different from the normal voltage is applied to the connection terminal of the stop assist ECU 20. The CPU determines whether or not the hazard switch 26 has been operated, based on a change in voltage of the connection terminal. Incidentally, either the normal voltage or the pressing voltage may be “0 V”.

When the hazard switch 26 has not been operated, the CPU determines that the result is “No” in step 605, and proceeds to step 695 to temporarily end the present routine.

In contrast, when the hazard switch 26 has been operated, the CPU determines that the result is “Yes” in step 605, and proceeds to step 610. In step 610, the CPU determines whether or not the value of the operation flag Xope is “0”.

When the value of the operation flag Xope is “0”, the hazard switch 26 is located at the on position after moving from the off position, through the current operation of the hazard switch 26. Therefore, the CPU determines that the result is “Yes” in step 615, and carries out step 615 and step 620 in this order.

In step 615, the CPU sets the value of the operation flag Xope to “1”.

In step 620, the CPU determines whether or not the value of the abnormality flag Xi is “1”.

When the value of the abnormality flag Xi is “0”, the CPU determines that the result is “No” in step 620, and proceeds to step 625. In step 625, the CPU determines whether or not the value of the operation flag Xope is “0”.

When the value of the operation flag Xope is “1” (when the hazard switch 26 is located at the on position), the CPU determines that the result is “No” in step 625, and proceeds to step 630. In step 630, the CPU sets the value of the activation flag Xlump to “1”, and proceeds to step 695 to temporarily end the present routine.

After that, the hazard switch 26 is located at the off position after moving from the on position by being operated, the CPU determines, upon proceeding step 610, that the result is “No” in step 610, and proceeds to step 635. The CPU proceeds to step 635 to set the value of the operation flag Xope to “0”, and proceeds to step 620. The CPU determines that the result is “No” in step 620, and proceeds to step 625. The value of the operation flag Xope is set to “0” in step 635. Therefore, the CPU determines that the result is “Yes” in step 625, and proceeds to step 640. The CPU sets the value of the activation flag Xlump to “0” in step 640, and proceeds to step 695 to temporarily end the present routine.

Incidentally, instead of step 610, the CPU determines whether or not the voltage applied to the connection terminal of the stop assist ECU 20 is a pressing voltage. When the voltage applied to the connection terminal is a pressing voltage, the CPU determines that the result is “Yes” in step 610, and proceeds to step 615. When the voltage of the connection terminal is a normal voltage, the CPU determines that the result is “No” in step 610, and proceeds to step 635.

When the value of the abnormality flag Xi is “1” as soon as the CPU proceeds to step 620, the CPU determines that the result is “Yes” in step 620, and proceeds to step 645. In step 645, the CPU determines whether or not the value of the invalid time timer Tb is smaller than a threshold Tbth. Incidentally, the threshold Tbth is set in advance such that the value of the invalid time timer Tb becomes equal to the threshold Tbth as soon as the invalid time Tinv elapses from the abnormality detection timing.

When the value of the invalid time timer Tb is smaller than the threshold Tbth, the hazard switch 26 is operated before the lapse of the invalid time Tinv from the abnormality detection timing. Thus, the CPU determines that the hazard switch 26 has been operated by the passenger who has noticed that the driver has fallen into an abnormal state. In this case, the CPU determines that the result is “Yes” in step 645, proceeds to step 630 to set the value of the activation flag Xlump to “1” regardless of the value of the operation flag Xope, and proceeds to step 695 to temporarily end the present routine.

When the hazard switch 26 is operated before the lapse of the invalid time Tinv from the abnormality detection timing, the CPU sets the value of the activation flag Xlump to “1” regardless of the value of the operation flag Xope. Therefore, even when the hazard switch 26 is operated, the hazard lamps 60 continue to blink. Furthermore, in this case, the CPU does not set the value of the abnormality flag Xi to “0”, and hence continues to perform stop assist control. In other words, when the hazard switch 26 is operated before the lapse of the invalid time Tinv from the abnormality detection timing, the CPU invalidates the operation of the hazard switch 26. Thus, stop assist control can be prevented from being ended although the driver is still in the abnormal state. Furthermore, the hazard lamps 60 can be prevented from turning off during the performance of stop assist control.

In contrast, when the value of the invalid time timer Tb is equal to or larger than the threshold Tbth as soon as the CPU proceeds to step 625, the hazard switch 26 is operated upon or after the lapse of the invalid time Tinv from the abnormality detection timing. Therefore, the CPU determines that this operation of the hazard switch 26 has been performed by the driver who has recovered to a normal state. In this case, the CPU determines that the result is “No” in step 645, and proceeds to step 650. In step 650, the CPU sets the value of the abnormality flag Xi to “0”, and proceeds to step 625. When the value of the operation flag Xope is “1”, the CPU determines that the result is “No” in step 625, and proceeds to step 630 to set the value of the activation flag Xlump to “1”. When the value of the operation flag Xope is “0”, the CPU determines that the result is “Yes” in step 625, and proceeds to step 640 to set the value of the activation flag Xlump to “0”.

Accordingly, when the hazard switch 26 is operated upon or after the lapse of the invalid time Tinv from the abnormality detection timing, the CPU determines that the driver has recovered from the abnormal state to the normal state. In this state, the CPU sets the value of the abnormality flag Xi to “0”, and hence ends stop assist control. Thus, stop assist control can be prevented from being continued although the driver has recovered to the normal state. In this case, the CPU sets the value of the activation flag Xlump in accordance with the value of the operation flag Xope. When the value of the operation flag Xope is “1”, the value of the activation flag Xlump is set to “1”. When the value of the operation flag Xope is “0”, the value of the activation flag Xlump is set to “0”.

Accordingly, in the case where the operation switch is operated after the lapse of the invalid time Tinv from the abnormality detection timing, the CPU continues to activate the hazard lamps 60 when the operation switch is located at the on position, and deactivates the hazard lamps 60 when the operation switch is located at the off position. In other words, when the operation switch is operated after the lapse of the invalid time Tinv from the abnormality detection timing, the CPU ends stop assist control, and continues to activate the hazard lamps 60 as long as the operation switch is located at the on position. Thus, the occurrence of a situation where the hazard lamps 60 are off although the hazard switch 26 is located at the on position, and a situation where the hazard lamps 60 blink although the hazard switch 26 is located at the off position can be prevented. As a result, the driver can be prevented from getting confused.

<Activation Control Routine>

The CPU executes an activation control routine indicated by a flowchart in FIG. 7, at intervals of a predetermined time.

Accordingly, at a predetermined timing, the CPU starts a process from step 700 of FIG. 7, and proceeds to step 705. In step 705, the CPU determines whether or not the value of the activation flag Xlump is “1”.

When the value of the activation flag Xlump is “1”, the CPU determines that the result is “Yes” in step 705, and proceeds to step 710. In step 710, the CPU activates (blinks) the hazard lamps 60 by transmitting an activation command to the hazard lamps 60, and proceeds to step 795 to temporarily end the present routine.

When the value of the activation flag Xlump is “0”, the CPU determines that the result is “No” in step 705, and proceeds to step 715. In step 715, the CPU deactivates (turns off) the hazard lamps 60 by transmitting a stop command to the hazard lamps 60, and proceeds to step 795 to temporarily end the present routine.

As is understood from the foregoing, when the hazard switch 26 is operated upon or after the lapse of the invalid time Tinv from the abnormality detection timing, the present assist device 10 determines that the operation of the hazard switch 26 has been performed by the driver who has recovered to a normal state, and ends stop assist control. Thus, the present assist device 10 can prevent stop assist control from being continued although the driver has recovered to the normal state. Furthermore, when the hazard switch 26 is operated before the lapse of the invalid time Tinv from the abnormality detection timing, the present assist device 10 determines that the operation of the hazard switch 26 has been performed by the passenger who has noticed that the driver has fallen into an abnormal state, and continues stop assist control. Thus, the present assist device 10 can prevent stop assist control from being ended although the driver has fallen into the abnormal state.

(Modification Examples)

The passenger of the vehicle VA may notice that the driver has fallen into an abnormal state, before the fulfillment of the abnormality condition, and operate the hazard switch 26. In this case, stop assist control is desired to be started even when the abnormality condition is not fulfilled. On the other hand, when stop assist control is started through all the operations of the hazard switch 26 before the fulfillment of the abnormality condition, stop assist control may be started although the driver is in a normal state.

Thus, if a tentative abnormality condition that is fulfilled at an earlier timing than the abnormality condition is fulfilled when the hazard switch 26 is operated before the fulfillment of the abnormality condition, the stop assist device 10 according to the present modification example determines that the driver has fallen into the abnormal state, and starts stop assist control.

For example, the tentative abnormality condition is a condition that is fulfilled when the foregoing unoperated state has continued for a second time. The second time is set in advance to a time shorter than the first time. Accordingly, the tentative abnormality condition is a condition including only one or some of conditions for fulfilling the abnormality condition, and is a condition that is fulfilled at an earlier timing than the abnormality condition. The driver is less likely to have fallen into the abnormal state upon the fulfillment of the tentative abnormality condition than upon the fulfillment of the abnormality condition.

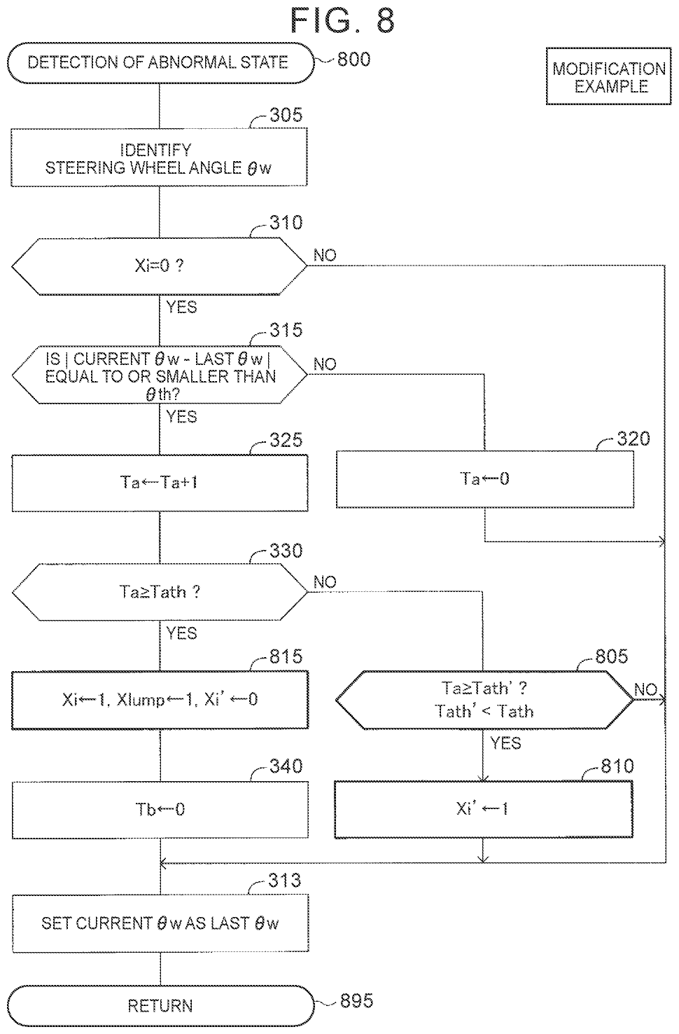

The present modification example is different from the foregoing embodiment in the abnormality detection routine and the hazard switch operation control routine. First of all, the abnormality detection routine of the present modification example will be described with reference to FIG. 8. Incidentally, in FIG. 8, steps in which the same processing is performed as in those shown in FIG. 3 are denoted by the same symbols as used in FIG. 3 respectively, and the description thereof will be omitted.

At a predetermined timing, the CPU starts a process from step 800 shown in FIG. 8. When the value of the abnormality flag is “0” in the unoperated state (|current θw−last θw|≤θwth), the CPU determines that the result is “Yes” in step 310 shown in FIG. 8, determines that the result is “Yes” in step 315 shown in FIG. 8, carries out step 325 shown in FIG. 8, and proceeds to step 330 shown in FIG. 8. When the value of the abnormality detection timer Ta is smaller than the threshold Tath as soon as the CPU proceeds to step 330 shown in FIG. 8, the CPU determines that the result is “No” in step 330, and proceeds to step 805 to determine whether or not the tentative abnormality condition is fulfilled.

In step 805, the CPU determines whether or not the value of the abnormality detection timer Ta is equal to or larger than a threshold Tath′. The threshold Tath′ is set in advance to a value smaller than the threshold Tath, and is set in advance such that the value of the abnormality detection timer Ta becomes equal to the threshold Tath′ when the unoperated state continues for the second time.

When the value of the abnormality detection timer Ta is smaller than the threshold Tath′ (i.e., when the tentative abnormality condition is not fulfilled), the CPU determines that the result is “No” in step 805, carries out step 313 shown in FIG. 8, and proceeds to step 895 to temporarily end the present routine.

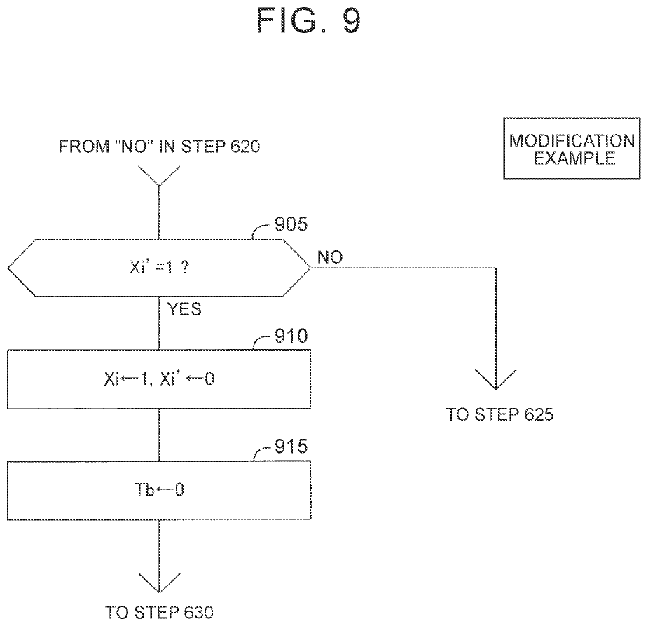

In contrast, when the value of the abnormality detection timer Ta is equal to or larger than the threshold Tath′ (i.e., when the tentative abnormality condition is fulfilled), the CPU determines that the result is “Yes” in step 805, and proceeds to step 810. In step 810, the CPU sets the value of a tentative abnormality flag Xi′ to “1”, and proceeds to step 895 to temporarily end the present routine. The value of the tentative abnormality flag Xi′ is set to “1” when the tentative abnormality condition is fulfilled. The value of the tentative abnormality flag Xi′ is set to “0” when the value of the abnormality flag Xi is set to “1” (see later-described step 815 and later-described step 910 shown in FIG. 9). Furthermore, the CPU determines whether or not a recovery condition is fulfilled when the value of the tentative abnormality flag Xi′ is “1”, and sets the value of the tentative abnormality flag Xi′ to “0” when the recovery condition is fulfilled. Incidentally, the value of the tentative abnormality flag Xi′ is set to “0” in the foregoing initial routine as well.

On the other hand, when it is determined that the result is “Yes” in step 330 shown in FIG. 8 (i.e., when the abnormality condition is fulfilled), the CPU proceeds to step 815, sets the value of the abnormality flag Xi to “1”, sets the value of the activation flag Xlump to “1”, and sets the value of the tentative abnormality flag Xi′ to “0”. After that, the CPU carries out step 340 shown in FIG. 8 and step 313 shown in FIG. 8, and proceeds to step 895 to temporarily end the present routine.

Next, the hazard switch operation control routine of the present modification example will be described with reference to FIG. 9. When the hazard switch 26 is operated (“Yes” in step 605 shown in FIG. 6), the CPU sets the value of the operation flag Xope in accordance with the position of the hazard switch 26 that has moved through the operation (step 610, step 615, and step 630 shown in FIG. 6), and proceeds to step 620 shown in FIG. 6. When it is determined that the result is “No” in step 620 shown in FIG. 6 (i.e., if the hazard switch 26 is operated when the value of the abnormality flag Xi is “0”), the CPU proceeds to step 905 shown in FIG. 9. In step 905, the CPU determines whether or not the value of the tentative abnormality flag Xi′ is “1”.

When the value of the tentative abnormality flag Xi′ is “0”, the CPU determines that the result is “No” in step 905, and proceeds to step 625 shown in FIG. 6.

In contrast, when the value of the tentative abnormality flag Xi′ is “1”, the CPU determines that the result is “Yes” in step 905, and carries out step 910 and step 915.

In step 910, the CPU sets the value of the abnormality flag Xi to “1”, and sets the value of the tentative abnormality flag Xi′ to “0”.

In step 915, the CPU sets the value of the invalid time timer Tb to “0”.

After that, the CPU proceeds to step 630 shown in FIG. 6 to set the value of the activation flag Xlump to “1”, and proceeds to step 695 shown in FIG. 6 to temporarily end the present routine.

As is understood from the foregoing, if the hazard switch 26 is operated when the abnormality condition is not fulfilled but the tentative abnormality condition is fulfilled, the CPU sets the value of the abnormality flag Xi to “1” in step 910, and sets the value of the activation flag Xlump to “1” in step 630 shown in FIG. 6. Thus, if the hazard switch 26 is operated when the abnormality condition is not fulfilled but the tentative abnormality condition is fulfilled, the CPU starts stop assist control, and can start activating the hazard lamps 60.

The disclosure is not limited to the foregoing embodiment, but various modification examples can be adopted within the scope of the disclosure.

The hazard switch 26 may be configured to be located at the on position only while the operator performs pressing operation, and to return to the off position when the operator cancels pressing operation. With the hazard switch 26 thus configured, the states of the hazard lamps 60 are changed over every time the operator performs pressing operation. That is, when the hazard switch 26 is subjected to pressing operation with the hazard lamps 60 turned off, the hazard lamps 60 blink. When the hazard switch 26 is subjected to pressing operation with the hazard lamps 60 blinking, the hazard lamps 60 are turned off. Incidentally, a switch other than that of the foregoing example is also applicable as the hazard switch 26.

In the foregoing embodiment, the abnormality condition is fulfilled when the amount of change in the steering wheel angle θw has remained equal to or smaller than the threshold for the first time or more. A steering torque may be used instead of the amount of change in the steering wheel angle θw. The steering torque is a torque that acts on a steering shaft (not shown) in accordance with the amount of change in the steering wheel angle θw.

Furthermore, the abnormality condition may be a condition that is fulfilled when neither the accelerator operation amount AP nor the brake operation amount BP has changed and the steering torque has remained equal to “0” for a first predetermined time.

Furthermore, the abnormality condition may be a condition that is fulfilled when a non-gripped state in which the driver does not grip the steering wheel has continued for the first time or more. In this case, the steering wheel is provided with a sensor for detecting whether or not the driver grips the steering wheel.

It may be determined whether or not the abnormality condition is fulfilled, through the use of the so-called “driver monitoring art” disclosed in Japanese Unexamined Patent Application Publication No. 2013-152700 (JP 2013-152700 A). To be more specific, a member in a cabin (e.g., the steering wheel, a pillar, or the like) is provided with a camera that photographs the driver. The stop assist ECU 20 monitors the direction of the driver's line of sight or the orientation of the driver's face, through the use of an image photographed by the camera. When the direction of the driver's line of sight or the orientation of the driver's face has been a direction other than a forward direction, the stop assist ECU 20 determines that the driver is in an abnormal state. Accordingly, the abnormality condition may be a condition that is fulfilled when the direction of the driver's line of sight or the orientation of the driver's face has been a direction other than the forward direction for the first time.

In stop assist control, the stop assist ECU 20 may perform steering control such that the vehicle VA does not stray from a running lane in which the vehicle VA currently runs, based on white line information, when the vehicle VA decelerates.

The foregoing description has been given on the assumption that the hazard lamps 60 blink during the activation thereof. However, the hazard lamps 60 may be on during the activation thereof.

The drive source of the vehicle VA may be an internal combustion engine and an electric motor, or only an electric motor. That is, the disclosure is applicable to a hybrid vehicle and an electric vehicle as well.

What is claimed is:

1. A stop assist device comprising:
an operation switch that is operated to activate a hazard lamp of a vehicle and deactivate the hazard lamp; and
a control unit configured to determine whether or not an abnormality condition that is fulfilled when a driver of the vehicle falls into an abnormal state in which the driver is unable to drive the vehicle is fulfilled, and start stop assist control for stopping the vehicle through automatic deceleration of the vehicle and start activating the hazard lamp upon arrival of an abnormality detection timing when it is determined that the abnormality condition is fulfilled, wherein
the control unit is configured to continue to perform the stop assist control when the operation switch is operated before lapse of a predetermined invalid time from the abnormality detection timing during performance of the stop assist control, and end the stop assist control when the operation switch is operated after lapse of the invalid time from the abnormality detection timing during performance of the stop assist control.

2. The stop assist device according to claim 1, wherein
the control unit is configured to determine whether or not a tentative abnormality condition including only one or some of conditions for fulfilling the abnormality condition is fulfilled, and start activating the hazard lamp and start the stop assist control when the operation switch is operated in a period from a tentative abnormality detection timing when it is determined that the tentative abnormality condition is fulfilled to the abnormality detection timing.

3. The stop assist device according to claim 1, wherein
the control unit is configured to continue activation of the hazard lamp when the operation switch is operated before lapse of the invalid time from the abnormality detection timing during performance of the stop assist control.

4. The stop assist device according to claim 1, wherein
the operation switch is configured to move to an on position upon being subjected to pressing operation when the operation switch is at an off position, remain at the on position when the pressing operation is canceled, move to the off position upon being subjected to pressing operation when the operation switch is at the on position, and remain at the off position when the pressing operation is canceled, and
the control unit is configured to activate the hazard lamp as long as the operation switch is at the on position, even when the operation switch is operated after lapse of the invalid time from the abnormality detection timing during performance of the stop assist control.

5. The stop assist device according to claim 1, wherein
the control unit is configured to continue activation of the hazard lamp when the operation switch is operated after lapse of the invalid time from the abnormality detection timing during performance of the stop assist control.

6. The stop assist device according to claim 1, wherein
the control unit is configured to deactivate the hazard lamp when the operation switch is operated after lapse of the invalid time from the abnormality detection timing during performance of the stop assist control.
